(19) United States
(12) Patent Application Publication
(10) Pub. No.: US 2018/0247721 A1
(43) Pub. Date: Aug. 30, 2018

(54) PLANT OPERATION ASSISTANCE SYSTEM AND PLANT OPERATION ASSISTANCE METHOD

(71) Applicant: MITSUBISHI HEAVY INDUSTRIES, LTD., Tokyo (JP)

(72) Inventors: Hitoi Ono, Tokyo (JP); Satoshi Hanada, Tokyo (JP); Eisuke Noda, Tokyo (JP)

(73) Assignee: MITSUBISHI HEAVY INDUSTRIES, LTD., Tokyo (JP)

(21) Appl. No.: 15/553,001

(22) PCT Filed: Jan. 20, 2016
(86) PCT No.: PCT/JP2016/051542

§ 371 Date: Aug. 23, 2017

(30) Foreign Application Priority Data
Feb. 25, 2015 (JP) 2015-035664

(51) Int. Cl. G21D 3/00; G05B 17/02; G21D 3/04; G21C 7/36; G21C 17/00

(52) U.S. Cl. CPC G21D 3/001; G05B 17/02; G21D 3/04; G21C 7/36; G21D 2003/007; G06F 2217/10; G21D 2003/002; G21D 2003/005; G21C 17/00

(57) ABSTRACT

A plant operation assistance system includes: a data obtaining unit-configured to obtain monitoring data indicating state quantity of a plant, the state quantity being detected by a sensor; an identifying unit configured to identify, based on the state quantity, a probability distribution of the monitoring data; a model generation unit configured to generate, based on a plant parameter composed from a database including design information of the plant, a stochastic model of the plant; a data processing unit configured to assign the probability distribution to the monitoring data obtained by the data obtaining unit; and a prediction unit configured to input the monitoring data assigned with the probability distribution, into the stochastic model, and predicts a state of the plant.

### FIELD

The present invention relates to a plant operation assistance system and a plant operation assistance method.

### BACKGROUND

States of plants may be monitored, for determination of current states of the plants based on the monitoring data and existing databases, such as design data, or for prediction of future states of the plants. In Patent Literature 1, an operation assistance apparatus, which uses a prediction simulator that predicts a future operation state based on monitoring data, is disclosed. In Patent Literature 2 and Patent Literature 3, estimation of parameters by use of a probability theory called “Bayes' theorem” is disclosed. Further, a technique for estimating and visualizing unobserved state quantity by using a deterministic model is disclosed in Non-Patent Literature 1.

Further, a technique for constructing a diagnostic model for a spacecraft by using a stochastic model called “Dynamic Bayesian Networks, and performing abnormality diagnosis is disclosed in Non-Patent Literature 2.

### CITATION LIST

### Patent Literature

Patent Literature 1: Japanese Unexamined Patent Application Publication No. 2010-026842 A
Patent Literature 2: Japanese Unexamined Patent Application Publication No. 2003-271231 A
Patent Literature 3: Japanese Unexamined Patent Application Publication No. 2012-009064 A

### Non-Patent Literature

Non-Patent Literature 1: Yokogawa Technical Report, Vol. 56, No. 1 (2013)
Non-Patent Literature 2: “Spacecraft Diagnosis Method Using Dynamic Bayesian Networks”, Journal of Japanese Society for Artificial Intelligence, Vol. 21, No. 1F (2006)

### SUMMARY

### Technical Problem

At the time of emergency, disaster, and the like in a plant, monitoring data of the plant may include much uncertainty, and prediction of a state of the plant may become difficult. In particular, in a case where a deterministic model as disclosed in Patent Literature 1 and Non-Patent Literature 1 is used, if the monitoring data include uncertainty, reliability of prediction results is reduced. When the plant is operated in reliance on these prediction results, appropriate operation of the plant becomes difficult.

The present invention aims to provide a plant operation assistance system and a plant operation assistance method, which enable prediction of a state of a plant in consideration of uncertainty in monitoring data and assistance in operation of the plant.

### Solution to Problem

The present invention provides a plant operation assistance system, including a data obtaining unit configured to obtain monitoring data indicating state quantity of a plant, the state quantity being detected by a sensor, an identifying unit configured to identify, based on the state quantity, a probability distribution of the monitoring data, a model generation unit configured to generate, based on a plant parameter composed from a database including design information of the plant, a stochastic model of the plant, a data processing unit configured to assign the probability distribution to the monitoring data obtained by the data obtaining unit, and a prediction unit configured to input the monitoring data assigned with the probability distribution into the stochastic model and predict a state of the plant.

According to the present invention, since the monitoring data that have been added with the probability distribution are input into the stochastic model; which part of, to what extent, and with a probability of what level, the plant is abnormal, are able to be predicted. Further, from the prediction results, the degree of uncertainty in the monitoring data and the reliability of the prediction results are able to be estimated. Accordingly, in consideration of the uncertainty in the monitoring data and the reliability of the prediction results, the plant is able to be operated.

In the present invention, it is preferable that the identifying unit is configured to identify the probability distribution with an output command of the plant being an index.

Thereby, states of the plant corresponding to various output commands are able to be predicted.

In the present invention, the plant operation assistance system may include an updating unit configured to update the stochastic model with a plant parameter identified based on a deterministic model of the plant. Thereby, even if the plant parameter is changed, the state of the plant is able to be predicted.

The present invention provides a plant operation assistance method, including steps of obtaining monitoring data indicating state quantity of a plant, the state quantity being detected by a sensor, identifying, based on the state quantity, a probability distribution of the monitoring data, generating, based on a plant parameter composed from a database including design information of the plant, a stochastic model of the plant, assigning the probability distribution to the obtained monitoring data, and inputting the monitoring data assigned with the probability distribution into the stochastic model and predicting a state of the plant.

According to the present invention, a state of a plant is able to be predicted appropriately, and the plant is able to be operated in consideration of uncertainty in monitoring data and reliability of prediction results.

### Advantageous Effects of Invention

According to the present invention, a plant operation assistance system and a plant operation assistance method, which enable: prediction of a state of a plant in consideration of uncertainty in monitoring data; and assistance in operation of the plant, are provided.

### BRIEF DESCRIPTION OF DRAWINGS

FIG. 1 is a functional block diagram illustrating an example of a plant operation assistance system according to an embodiment.

FIG. 2 is a schematic diagram illustrating an example of a plant according to the embodiment.

FIG. 3 is a diagram for explanation of an example of probability distributions of monitoring data according to the embodiment.

FIG. 4 is a schematic diagram illustrating an example of a stochastic model according to the embodiment.

FIG. 5 is a flow chart illustrating an example of a plant operation assistance method according to the embodiment.

FIG. 6 is a diagram illustrating an example of the monitoring data according to the embodiment.

FIG. 7 is a diagram illustrating an example of the monitoring data according to the embodiment.

FIG. 8 is a diagram illustrating an example of the monitoring data according to the embodiment.

FIG. 9 is a diagram illustrating an example of the monitoring data according to the embodiment.

FIG. 10 is a diagram illustrating an example of prediction results according to the embodiment.

FIG. 11 is a diagram illustrating an example of the prediction results according to the embodiment.

FIG. 12 is a diagram illustrating an example of the prediction results according to the embodiment.

FIG. 13 is a functional block diagram illustrating another example of the plant operation assistance system according to the embodiment.

### DESCRIPTION OF EMBODIMENTS

Hereinafter, embodiments according to the present invention will be described while reference is made to the drawings, but the present invention is not limited to these embodiments. Components of the respective embodiments described below may be combined with one another, as appropriate. Further, a part of the components may be not used.

[Outline of Plant Operation Assistance System]

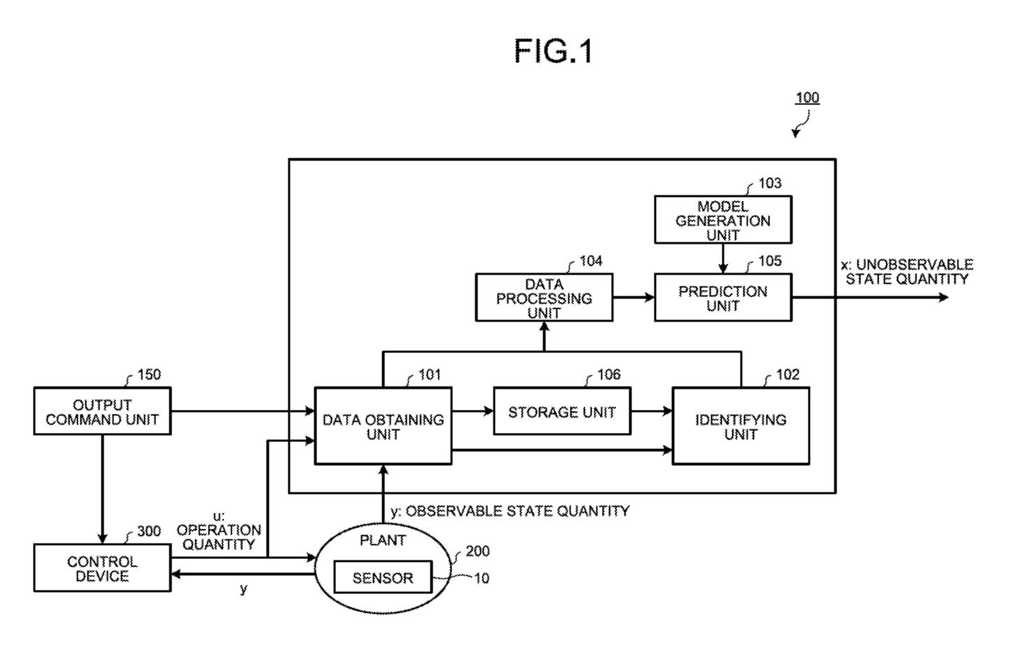

FIG. 1 is a functional block diagram illustrating an example of a plant operation assistance system 100 according to an embodiment. The plant operation assistance system 100 includes a computer system. As illustrated in FIG. 1, the plant operation assistance system 100 includes: a data obtaining unit 101 that obtains monitoring data indicating state quantity y of a plant 200, the state quantity y having been detected by a sensor 10; an identifying unit 102 that identifies, based on the state quantity y of the plant 200, a probability distribution of the monitoring data; a model generation unit 103 that generates, based on a plant parameter composed from a database including design information of the plant 200, a stochastic model of the plant 200; a data processing unit 104 that assigns the probability distribution to the monitoring data obtained by the data obtaining unit 101; a prediction unit 105 that inputs the monitoring data that have been assigned with the probability distribution, into the stochastic model, and predicts a state of the plant 200; and a storage unit 106 that stores therein data obtained by the data obtaining unit 101.

The plant 200 is controlled by a control device 300. The control device 300 includes a computer system, and outputs operation quantity u for operating the plant 100, to the plant operation assistance system 100 and the plant 200. The state quantity y detected by the sensor 10 is output to the plant operation assistance system 100 and the control device 300.

An output command unit 150 is connected to the control device 300. The output command unit 150 has an operation input unit that is operated by an operator, and generates, based on an operation, a command signal. The command signal is an output command signal instructing an output of the plant 200.

[Nuclear Power Plant]

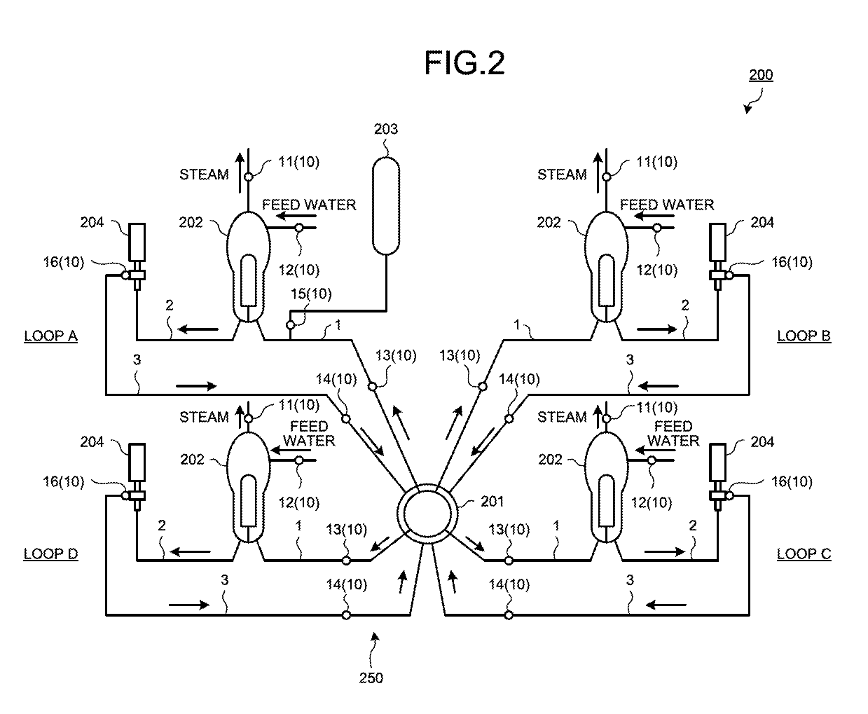

FIG. 2 is a schematic diagram illustrating an example of the plant 200 according to the embodiment. In this embodiment, an example, in which the plant 200 is a nuclear power plant 200, will be described. FIG. 2 illustrates a nuclear reactor vessel 201 and a primary cooling system 250, of the nuclear power plant 200.

The nuclear power plant 200 includes: the nuclear reactor vessel 201 having a reactor core; a steam generator 202; and a pressurizer 203 that pressurizes the primary cooling system 250. The nuclear reactor vessel 201 heats up primary cooling water. The primary cooling water that has been heated up by the nuclear reactor vessel 201 is sent to the steam generator 202 via a hot leg 1, which is a high temperature side piping. The steam generator 202 generates steam of secondary cooling water by performing heat exchange between the high temperature and high pressure primary cooling water that has been supplied from the nuclear reactor vessel 201 and the secondary cooling water (feed water) that has been supplied from a secondary cooling system. The steam generated by the steam generator 202 is supplied to a turbine generator (not illustrated) via the secondary cooling system. The primary cooling water that has been cooled in the steam generator 202 is sent to a cold leg 3, which is a low temperature side piping, via a crossover leg 2 and a primary cooling water pump 204, flows through the cold leg 3, and thereafter, is supplied to the nuclear reactor vessel 201.

In this embodiment, the primary cooling system 250 has four loops (circulation systems), which are a loop A, a loop B, a loop C, and a loop D. The primary cooling water that has been heated up by the nuclear reactor vessel 201 is supplied to each of the loops A, B, C, and D. Each of the loops A, B, C, and D has therein the steam generator 202, the primary cooling water pump 204, the hot leg 1, the crossover leg 2, and the cold leg 3. The primary cooling water that has flown through each of the loops A, B, C, and D is returned to the nuclear reactor vessel 201.

In this embodiment, examples of the state quantity y of the nuclear power plant 200, the state quantity y being observable by use of the sensor 10, include: main steam temperature Tₘₛ indicating temperature of the steam of the secondary cooling water generated from the steam generator 202; feed water temperature T_{fw} indicating temperature of the secondary cooling water supplied to the steam generator 202; high side temperature Tₕₒ indicating temperature of the primary cooling water flowing through the hot leg 1; low side temperature T_{co} indicating temperature of the primary cooling water flowing through the cold leg 3; pressure P_{rcp} indicating pressure in the primary cooling system 250; and flow rate G_{rcp} of the primary cooling water pump 204.

The sensor 10 includes: a main steam temperature sensor 11 that detects the main steam temperature Tₘₛ; a feed water temperature sensor 12 that detects the feed water temperature T_{fw}; a high side temperature sensor 13 that detects the high side temperature Tₕₒ; a low side temperature sensor 14 that detects the low side temperature T_{co}; a pressure sensor 15 that detects the pressure P_{rcp}; and a flow rate sensor 16 that detects the flow rate G_{rcp}.

[Identifying Unit]

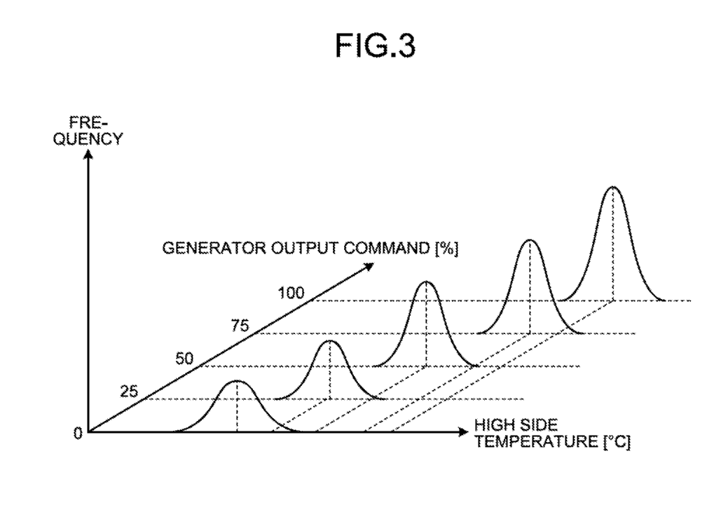

The identifying unit 102 identifies, based on the observable state quantity y of the nuclear power plant 200, a probability distribution of the monitoring data. FIG. 3 is a schematic diagram for explanation of an example of probability distributions of monitoring data. Hereinafter, description will be made by assuming that the state quantity y of the nuclear power plant 200 is the high side temperature Tₕₒ.

The identifying unit 102 statistically derives, based on plural monitoring data (accumulated data) on the high side temperature Tₕₒ obtained in a predetermined past time period, a probability distribution for the high side temperature Tₕₒ. The predetermined past time period may be, for example, any of: one day; one week; one month; one year; and so on. As the probability distribution, an average value and variance of the high side temperature Tₕₒ in the predetermined time period are derived.

Even if the nuclear power plant 200 is operating normally, the high side temperature Tₕₒ may fluctuate. In a predetermined time period when the nuclear power plant 200 is operating normally, the high side temperature sensor 13 monitors the high side temperature Tₕₒ, and regularly outputs monitoring data on the high side temperature Tₕₒ, to the data obtaining unit 101. The monitoring data on the high side temperature Tₕₒ, which have been output from the high side temperature sensor 13 and obtained by the data obtaining unit 101, are accumulated in the storage unit 106. The identifying unit 102 derives, based on the plural monitoring data on the high side temperature Tₕₒ in the predetermined time period, the plural monitoring data having been stored in the storage unit 106, an average value and variance of the high side temperature Tₕₒ.

In this embodiment, the identifying unit 102 identifies, with an output command of the nuclear power plant 200 being an index, the probability distribution. The output command is a generator output command MWD. When the generator output command MWD is changed, an output range of the nuclear power plant 200 is changed, and in association with that change, the average value and variance of the high side temperature Tₕₒ are changed. The identifying unit 102 derives the probability distribution for the high side temperature Tₕₒ, for each of plural different generator output commands MWDs.

Graphs illustrated in FIG. 3 illustrate relations between the high side temperature Tₕₒ [° C.], the generator output commands MWDs [%], and frequency of obtainment of the monitoring data on the high side temperature Tₕₒ. In the example illustrated in FIG. 3, the average value and variance of the high side temperature Tₕₒ at each of the generator output commands MWDs, 0[%], 25[%], 50[%], 75[%], and 100[%], as main operating points of the nuclear power plant 200, have been derived.

An average value and variance of the high side temperature Tₕₒ at a generator output command MWD (for example, 60[%]) other than the main operating points may be found, based on the monitoring data, by interpolation.

The identifying unit 102 is able to derive, similarly to the probability distribution of the high side temperature Tₕₒ, as the observable state quantity y, a probability distribution for the main steam temperature Tₘₛ, a probability distribution for the feed water temperature T_{fw}, a probability distribution for the low side temperature T_{co}, a probability distribution for the pressure P_{rcp}, and a probability distribution for the flow rate G_{rcp}. Further, the identifying unit 102 may find a probability distribution for the operation quantity u.

[Data Processing Unit]

To the data processing unit 104, a probability distribution identified by the identifying unit 102 as described by reference to FIG. 3, and monitoring data of the nuclear power plant 200 obtained by the data obtaining unit 101 are input. The data processing unit 104 assigns the probability distribution to the monitoring data, and sends the monitoring data that have been assigned with the probability distribution, to the prediction unit 105.

[Model Generation Unit]

The model generation unit 103 generates, based on plant parameters composed from a database including design information of the nuclear power plant 200, a stochastic model of the nuclear power plant 200.

The plant parameters of the nuclear power plant 200 are specification data of the nuclear power plant 200, such as design data or characteristic data of devices in the nuclear power plant 200, or physical property data of the primary cooling water. The plant parameters are static known data that are able to be known from these design data. Examples of the plant parameters include, for example: the specific heat of the primary cooling water; and masses, heat transfer coefficients, and heat exchange amounts of the devices in the nuclear power plant 200.

The model generation unit 103 generates, based on the plant parameters composed from the database including the design information, and on the monitoring data indicating the state quantity y detected by the sensor 10, a stochastic model of the nuclear power plant 200. The stochastic model is a modeling technique that uses a probability theory called “Bayes' theorem”. In this embodiment, the model generation unit 103 generates the stochastic model of the nuclear power plant 200 by using a stochastic model called “Dynamic Bayesian Networks (DBNs)”. DBNs is a model obtained by expansion of Bayesian Networks (BNs) so as to be also applicable to a dynamic system, and is said to be a generic state space model encompassing Kalman filter models (KFMs), hidden Markov models (HMMs), and the like.

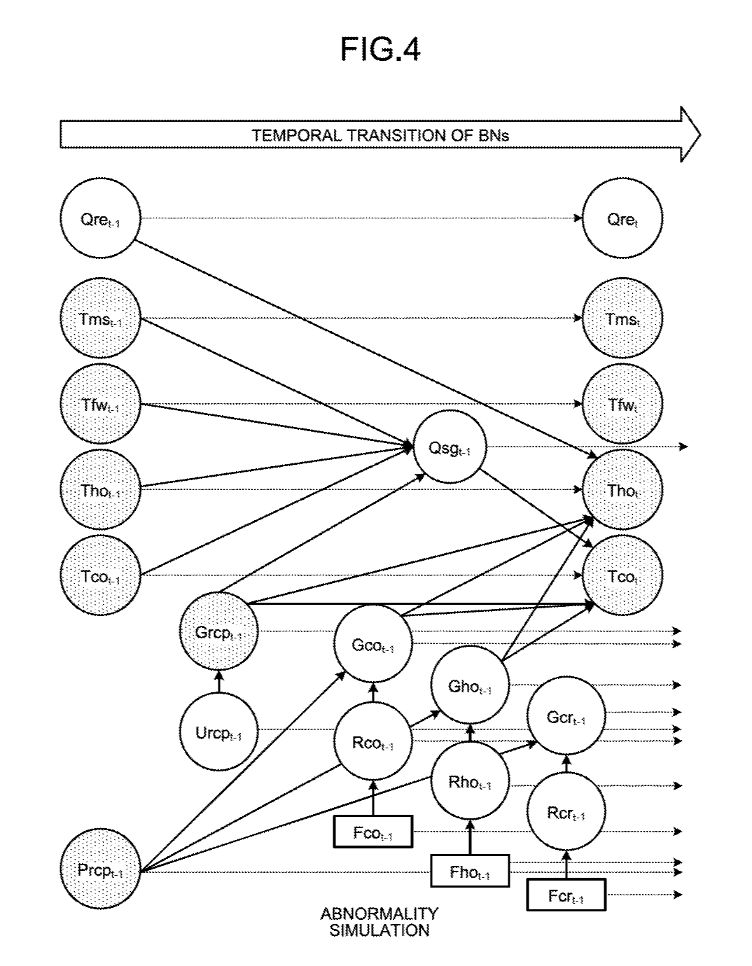

FIG. 4 is a schematic diagram illustrating an example of the stochastic model (hereinafter, referred to as a DBNs model) using Dynamic Bayesian Networks (DBNs), and illustrates a graph structure when the system of the nuclear power plant 200 is expressed by DBNs. In a DBNs model, transition distribution of each variable is expressed, and the unobservable state quantity x (hidden variable) at a time point (t−1) and a time point (t) is estimated from the observable state quantity y (variable) at the time point (t−1) and time point (t). In FIG. 4, the observable state quantity y is shaded values, and the unobservable state quantity x is unshaded values.

In this embodiment, as the unobservable state quantity x, reactor core heating value Qᵣₑ, heat exchange amount Q_{sg} of the steam generator 202, flow rate Gₕₒ of the hot leg 1, flow rate G_{cr} of the crossover leg 2; flow rate G_{co} of the cold leg 3, breakage diameter Rₕₒ of the hot leg 1, breakage diameter R_{cr} of the crossover leg 2, breakage diameter R_{co} of the cold leg 3, masses M_{sg1}, M_{sg2}, M_{sg3} and M_{sg4} of the steam generators 202, and a mass M_{core} of the reactor core are estimated.

Hereinafter, an example of the DBNs model will be described. As the observable state quantity y, the main steam temperature Tₘₛ of the respective loops A, B, C, and D will be denoted by Tₘₛ₁, Tₘₛ₂, Tₘₛ₃, and Tₘₛ₄, the feed water temperature T_{fw} thereof by T_{fw1}, T_{fw2}, T_{fw3}, and T_{fw4}, the high side temperature Tₕₒ thereof by Tₕₒ₁, Tₕₒ₂, Tₕₒ₃, and Tₕₒ₄, the low side temperature T_{co} thereof by T_{co1}, T_{co2}, T_{co3}, and T_{co4}, the flow rate G_{rcp} thereof by G_{rcp1}, G_{rcp2}, G_{rcp3}, and G_{rcp4}, flow rate of the secondary cooling water in the loop A by G_{fw1}, flow rate of main steam in the loop A by Gₘₛ₁, water level in the steam generators 202 of the respective loops A, B, C, and D by L_{sg1}, L_{sg2}, L_{sg3}, and L_{sg4}, and water level in the reactor core by L_{core}.

As the design information (plant parameters), the mass of the reactor core will be denoted by M_{core}, the heating value thereof by Qᵣₑ, the temperature by Tₕₒ, and the specific heat by cpₕₒ. Further, the masses of the steam generators 202 of the respective loops A, B, C, and D will be denoted by M_{sg1}, M_{sg2}, M_{sg3}, and M_{sg4}, the heat exchange amount Q_{sg} of the steam generators 202 thereof by Q_{sg1}, Q_{sg2}, Q_{sg3}, and Q_{sg4}, the specific heat of the primary cooling water in the hot legs 1 thereof by cpₕₒ₁, cpₕₒ₂, cpₕₒ₃, and cpₕₒ₄, and the specific heat of the primary cooling water in the cold legs 3 thereof by cp_{co1}, cp_{co2}, cp_{co3}, and cp_{co4}.

As an example of the DBNs model of the nuclear power plant 200, a part of the nuclear power plant 200 is able to be expressed by the following differential equations, Equation (1) to Equation (5).

$$\begin{matrix}{M}_{core} \cdot {cp}_{ho} \frac{{dT}_{ho}}{dt} = {G}_{rcp 1} \cdot {cp}_{co 1} \cdot {T}_{co 1} + {G}_{rcp 2} \cdot {cp}_{co 2} \cdot {T}_{co 2} + {G}_{rcp 3} \cdot {cp}_{co 3} \cdot {T}_{co 3} + {G}_{rcp 4} \cdot {cp}_{co 4} \cdot {T}_{co 4} - ( {G}_{rcp 1} + {G}_{rcp 2} + {G}_{rcp 3} + {G}_{rcp 4} ) \cdot {cp}_{ho} \cdot {T}_{ho} + {Q}_{re} & ( 1 ) \\ {M}_{sg 1} \cdot {cp}_{co 1} \frac{{dT}_{co 1}}{dt} = {G}_{rcp 1} \cdot {cp}_{ho 1} \cdot {T}_{ho 1} - {G}_{rcp 1} \cdot {cp}_{co 1} \cdot {T}_{co 1} - {Q}_{sg 1} & ( 2 ) \\ {M}_{sg 2} \cdot {cp}_{co 2} \frac{{dT}_{co 2}}{dt} = {G}_{rcp 2} \cdot {cp}_{ho 2} \cdot {T}_{ho 2} - {G}_{rcp 2} \cdot {cp}_{co 2} \cdot {T}_{co 2} - {Q}_{sg 2} & ( 3 ) \\ {M}_{sg 3} \cdot {cp}_{co 3} \frac{{dT}_{co 3}}{dt} = {G}_{rcp 3} \cdot {cp}_{ho 3} \cdot {T}_{ho 3} - {G}_{rcp 3} \cdot {cp}_{co 3} \cdot {T}_{co 3} - {Q}_{sg 3} & ( 4 ) \\ {M}_{sg 4} \cdot {cp}_{co 4} \frac{{dT}_{co 4}}{dt} = {G}_{rcp 4} \cdot {cp}_{ho 4} \cdot {T}_{ho 4} - {G}_{rcp 4} \cdot {cp}_{co 4} \cdot {T}_{co 4} - {Q}_{sg 4} & ( 5 )\end{matrix}$$

Further, as examples of the unobservable state quantity x, the heating value Qᵣₑ of the reactor core and the heat exchange amount Q_{sg1} of the steam generator 202 are able to be expressed by the following Equation (6) and Equation (7).

Qᵣₑ=f(MWD,Tₕₒ,T_{co1},T_{co2},T_{co3},T_{co4},G_{rcp1},G_{rcp2},G_{rcp3},G_{rcp4}) (6)

Q_{sg1}=f(MWD,Tₕₒ,T_{co1},T_{fw1},Tₘₛ₁,G_{rcp1},G_{fw1},Gₘₛ₁) (7)

As expressed by Equation (6) and Equation (7), the heating value Qᵣₑ and the heat exchange amount Q_{sg1} are expressed as functions of the generator output command MWD and the like.

Further, in the DBNs model, a conditional probability Pr is assigned to all of the variables. For example, for T_{co1,t}, with T_{co1,t-1}, T_{ho1,t-1}, G_{rcp1,t-1}, and Q_{sg1,t-1} being parent variables, a conditional probability like Equation (8) is assigned.

$$Pr ( {T}_{co 1 , t} \vert {T}_{co 1 , t - 1} , {T}_{ho 1 , t - 1} , {G}_{rcp 1 , t - 1} , {Q}_{sg 1 , t - 1} ) = N ( \frac{Δ t \cdot {G}_{rcp 1 , t - 1}}{{M}_{sg 1 , t} \cdot {cp}_{co 1 , t}} ( {cp}_{ho 1 , t - 1} \cdot {T}_{ho 1 , t - 1} - {cp}_{co 1 , t - 1} \cdot {T}_{co 1 , t - 1} - {Q}_{sg 1 , t - 1} , \sum ) ) \qquad ( 8 )$$

In Equation (8), Σ is a variance matrix of a normal distribution. In Equation (8), “Q_{sg1,t-1},Σ” is a parameter that is variable according to the generator output command MWD. By the DBNs model being made variable by the generator output command MWD, the DBNs model becomes a model, in which variation differences among the monitoring data according to the generator output commands MWDs are able to be considered.

[Prediction Unit]

The monitoring data that have been assigned with the probability distribution generated by the data processing unit 104, and the DBNs model that has been generated by the model generation unit 103 are input to the prediction unit 105. The prediction unit 105 inputs the monitoring data that have been assigned with the probability distribution, into the DBNs model, and outputs the unobservable state quantity x. Since the monitoring data that have been assigned with the probability distribution are input into the DBNs model, the degree of variation in the predicted state quantity x is able to be found.

[Plant Operation Assistance Method]

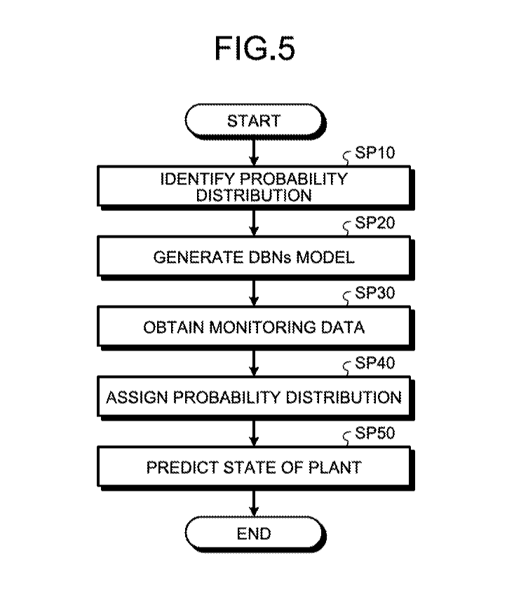

Next, an example of a plant operation assistance method according to this embodiment will be described. FIG. 5 is a flow chart illustrating the example of the plant operation assistance method according to this embodiment. In the following description, an example, in which a loss-of-coolant accident (LOCA) occurs in the nuclear power plant 200 and in which part of the loops A, B, C, and D breakage of a piping (leg) has occurred is estimated, will be described.

Based on plural monitoring data (accumulated data) obtained by use of the sensor 10 in a predetermined past time period, a probability distribution for those monitoring data is identified (Step SP10). The identifying unit 102 identifies at least probability distributions of the high side temperature Tₕₒ, the low side temperature T_{co}, the main steam temperature Tₘₛ, and the feed water temperature T_{fw}, for each of the loops A, B, C, and D.

The model generation unit 103 generates a DBNs model, based on plant parameters (Step SP20).

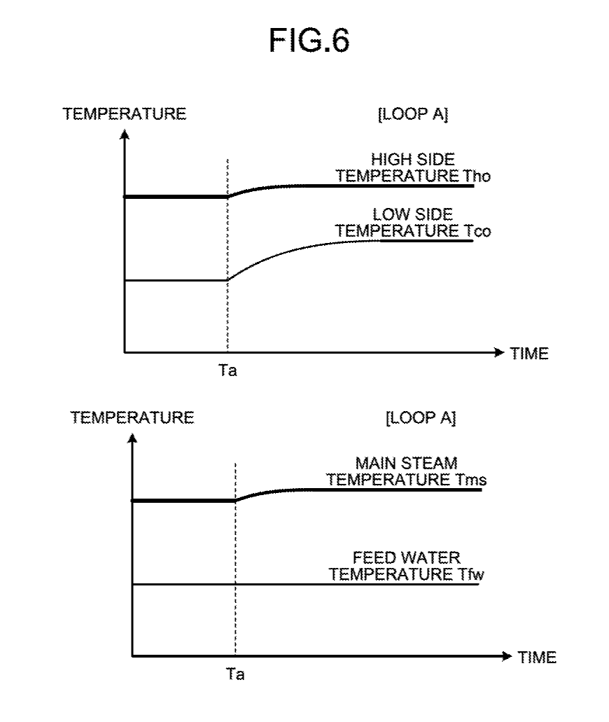

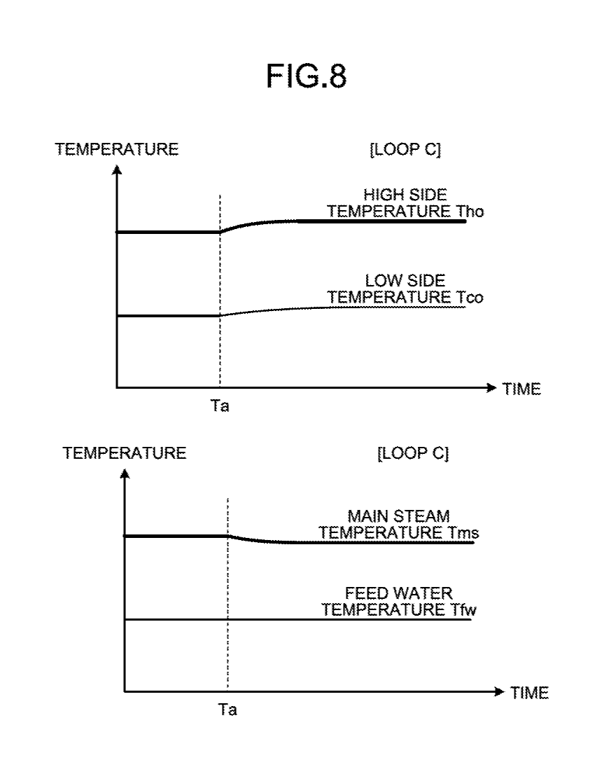

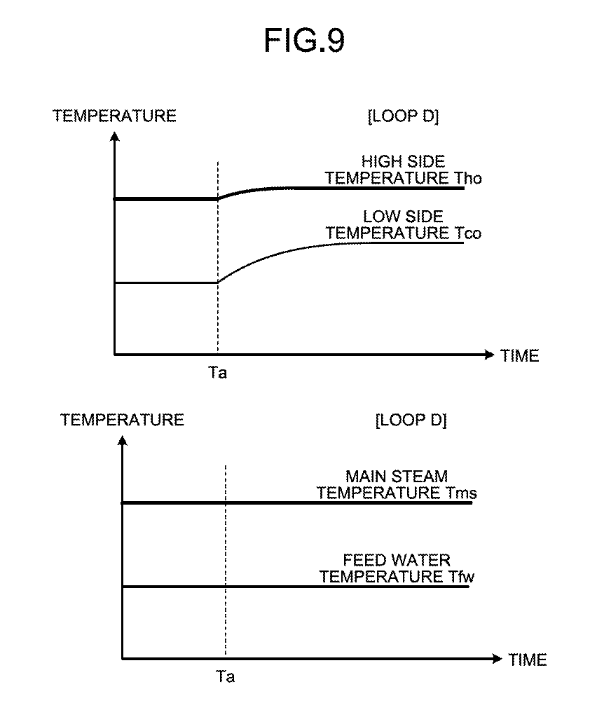

Monitoring data for the nuclear power plant 200 are obtained (Step SP30). FIG. 6 to FIG. 9 are respectively diagrams illustrating examples of the monitoring data for the loops A, B, C, and D. As illustrated in FIG. 6 to FIG. 9, the high side temperature Tₕₒ, the low side temperature T_{co}, the main steam temperature Tₘₛ, and the feed water temperature T_{fw}, for each of the loops A, B, C, and D are obtained as the monitoring data. In the graphs of FIG. 6 to FIG. 9, the horizontal axes represent time and the vertical axes represent temperature.

For example, if the crossover leg 2 of the loop A is broken and a loss-of-coolant accident occurs at a time point Ta, a phenomenon, in which the pressure loss in the crossover leg 2 is reduced, the flow rate of the primary cooling water flowing through the hot leg 1 is increased, and as illustrated in FIG. 6, the high side temperature Tₕₒ is increased, occurs. Further, when the flow rate of the primary cooling water flowing through the hot leg 1 is increased, as illustrated in FIG. 6, a phenomenon, in which the low side temperature T_{co} and the main steam temperature Tₘₛ are increased, occurs.

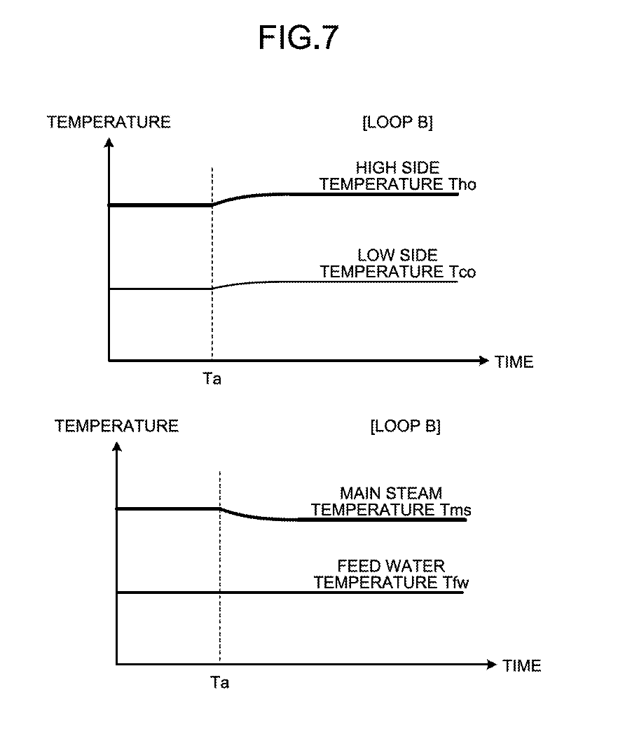

Since the primary cooling water flowing in each loop collects at the nuclear reactor vessel 201, and is thereafter supplied to each loop, the temperature in each of the loops B, C, and D also changes as illustrated in FIG. 7 to FIG. 9, due to the breakage of the crossover leg 2 of the loop A.

The data processing unit 104 assigns the probability distributions derived in Step SP10 to the monitoring data illustrated in FIG. 6 to FIG. 9 (Step SP40).

The prediction unit 105 inputs the monitoring data that have been assigned with the probability distributions into a stochastic model and predicts a state of the nuclear power plant 200 (Step SP50).

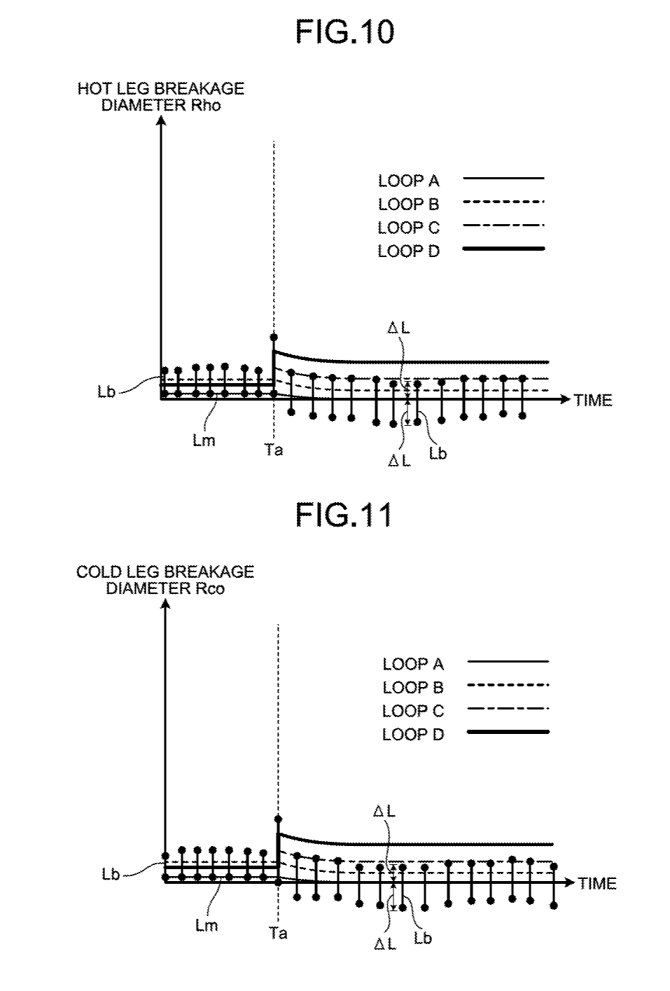

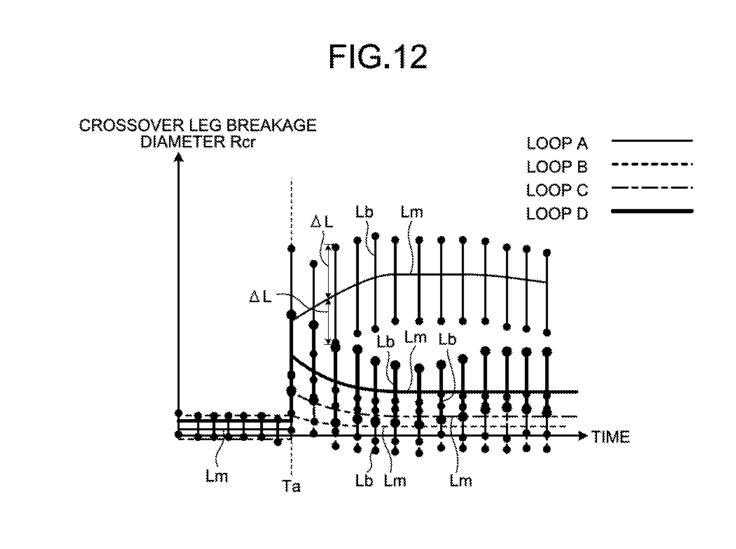

FIG. 10, FIG. 11, and FIG. 12 are diagrams illustrating relations between: the breakage diameter Rₕₒ of the hot leg 1, the breakage diameter R_{co} of the cold leg 3, and the breakage diameter R_{cr} of the crossover leg 2, as the unobservable state quantity x in the respective loops, the unobservable state quantity x having been predicted by the prediction unit 105; and time.

In each of FIG. 10 to FIG. 12, a line Lm extending horizontally indicates the central value of the predicted breakage diameter. A line Lb branching in a vertical direction from the line Lm indicates a variation (uncertainty) in the predicted breakage diameter.

As illustrated in FIG. 10 to FIG. 12, in a time period before the time point Ta, at which the loss-of-coolant accident occurs, the central values of the breakage diameters Rₕₒ, R_{co}, and R_{cr} of each loop are predicted to be substantially “0”. It can be understood that in this time period before the time point Ta also, the lines Lb are slightly present for the breakage diameters Rₕₒ, R_{co}, and R_{cr} of the loop A, and uncertainty is included. This is considered to be because under normal conditions where a loss-of-coolant accident has not occurred, there is also a variation (uncertainty) in the monitoring data of each of the sensors 11, 12, 13, and 14 provided in the loop A, and the probability distribution reflecting the variation has been assigned to the monitoring data. Accordingly, since the probability distribution has been assigned to the monitoring data when the breakage diameter is predicted from the monitoring data under normal conditions also, determination of whether the prediction results indicating that the loop A has broken are highly reliable is able to be made.

In the case where the crossover leg 2 of the loop A breaks and the loss-of-coolant accident occurs at the time point Ta, the prediction unit 105 predicts the breakage diameters Rₕₒ, R_{co}, and R_{cr} for each loop by using the data resulting from the assignment of the probability distributions to the monitoring data in FIG. 6 to FIG. 9. Since the hot leg 1 and the cold leg 3 are not broken, as illustrated in FIG. 10 and FIG. 11, in a time period after the time point Ta, the central values of the breakage diameters Rₕₒ and R_{co} are predicted to be substantially “0”. It can be understood that in this time period after the time point Ta also, the line Lb is present for the breakage diameters Rₕₒ and R_{co} of the loop A, and uncertainty is included. In the example illustrated in FIG. 10, when a difference between the maximum value or minimum value of the line Lb and the central value indicated by the line Lm is ΔL, it is predicted that there is a possibility that breakage with the breakage diameter Rₕₒ of the loop A in a range of “central value±ΔL” has occurred. As described above, with a variation (uncertainty), the breakage diameter Rₕₒ in the loop A is predicted. In the example illustrated in FIG. 10, the minimum value of the line Lb is less than “0”. Therefore, reliability of the prediction results for the breakage diameter Rₕₒ of the loop A is evaluated to be low.

Further, in the example illustrated in FIG. 10 and FIG. 11, the breakage diameters Rₕₒ and R_{co} of the loop D do not have a line Lb, but the central values thereof increase slightly. Therefrom, it is predicted that the hot leg 1 and the cold leg 3 of the loop D are likely to break, and it can be said that reliability of this prediction result is high.

As illustrated in FIG. 12, the central value of the breakage diameter R_{cr} of the loop A largely increases at the time point Ta, and it is predicted that the crossover leg 2 of the loop A has broken. It is understood that the breakage diameter R_{cr} of the loop A has a line Lb with a large difference ΔL from the central value, and the prediction results have variations.

Further, in the time period after the time point Ta, the central values of the breakage diameter R_{cr} of the loops B, C, and D increase, and it is predicted that the crossover legs 2 of the loops B, C, and D are likely to break. Reliability of the prediction results is able to be evaluated based on the length (difference ΔL) of the line Lb for the breakage diameter R_{cr} of each loop.

[Effects]

As described above, according to this embodiment, since monitoring data that have been assigned with probability distributions are input to a stochastic model (DBNs model); which part of, to what extent, and with a probability of what level, the nuclear power plant 200 is abnormal, are able to be predicted. Further, from prediction results, a degree of uncertainty in the monitoring data and reliability of the prediction results are able to be estimated. Accordingly, in consideration of the uncertainty in the monitoring data and the reliability of the prediction results, the nuclear power plant 200 is able to be operated. Furthermore, if a loss-of-coolant accident occurs, in consideration of the uncertainty in the monitoring data and the reliability of the prediction results, measures are able to be taken or decision making for the measures is able to be performed.

That is, as illustrated in FIG. 10, if a prediction result, which indicates that in the time period before the time point Ta, the breakage diameter Rₕₒ of the loop A includes a line Lb, is obtained, the monitoring data serving as the basis of the prediction results are able to be evaluated as including uncertainty.

Further, in the time period after the time point Ta also, if the value (length) of a line Lb is large, the reliability of the prediction results is able to be evaluated to be low. Furthermore, if the value of a line Lb before the time point Ta is small and the value of a line Lb after the time point Ta is large, it is able to be evaluated that there is a possibility that the monitoring data obtained after the time point Ta include much uncertainty.

In a conventional method, in which monitoring data not assigned with a probability distribution are input to a deterministic model; which part and how much (how many inches) of a piping is broken are able to be predicted. However, reliability of the prediction results is difficult to be evaluated.

In this embodiment, since monitoring data that have been assigned with probability distributions are input into a stochastic model, not only prediction of which part and how much (how many inches) of a piping are broken is possible, but also prediction by association between the degree of breakage and the probability (reliability) is possible, like, for example, a probability that breakage of 5 inches has occurred being found to be A % and a probability that breakage of 4 inches has occurred being found to be B %.

Further, in this embodiment, the identifying unit 102 identifies a probability distribution with a generator output command MWD of the nuclear power plant 200 being an index. Since there is a possibility that the probability distribution changes according to the generator output command MWD; with the generator output command MWD being an index, states of the nuclear power plant 200 corresponding to various generator output commands MWDs are able to be predicted.

### Other Embodiment

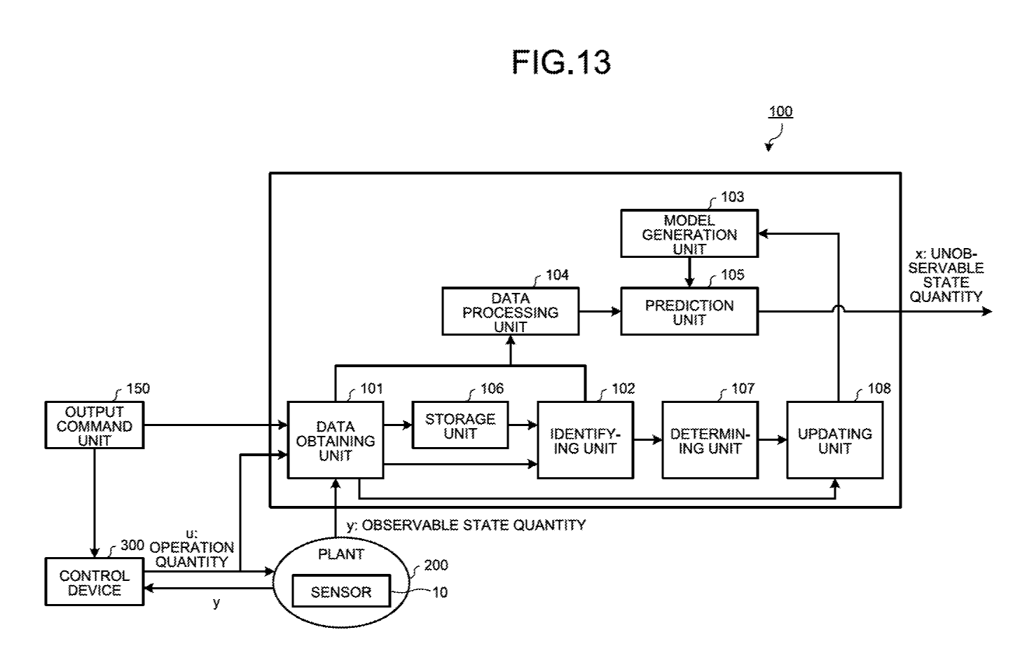

FIG. 13 is a functional block diagram illustrating another example of the plant operation assistance system 100. A characteristic point of this embodiment is in that an updating unit 108, which updates the stochastic model with plant parameters identified based on a deterministic model of the plant 200, is included.

As illustrated in FIG. 13, the plant operation assistance system 100 has a determining unit 107 and the updating unit 108. In the determining unit 107, whether or not a probability distribution (an average value and variance) is identifiable is determined. For example, in a time zone, in which the average value and variance largely deviate from actual results of design plan values and past accumulated values of the state quantity y, the determining unit 107 determines that a probability distribution is unidentifiable, and if a difference between the average value and variance, and the design plan values and past accumulated values is small, the determining unit 107 determines that a probability distribution is identifiable.

An identifiable state means a state where the average value and variance are stable, and that the plant 200 is in a steady state. If it has been determined by the determining unit 107 that a probability distribution is identifiable, that is, if it is determined that the plant 200 is in the steady state, the updating unit 108 identifies plant parameters and updates the stochastic model.

The updating unit 108 generates a deterministic model of the plant 200. Further, the state quantity y and operation quantity u of the plant 200 are input to the updating unit 108. By inputting the state quantity y and the operation quantity u into the deterministic model that has been modelled, the updating unit 108 identifies plant parameters of the plant 200 by fitting.

The plant parameters newly identified by the updating unit 108 are sent to the model generation unit 103. The model generation unit 103 updates the stochastic model with the plant parameters that have been identified based on the deterministic model of the plant 200.

Although the plant parameters are static data, the plant parameters may change. According to this embodiment, since plant parameters are identified based on a deterministic model of the plant 200, and a stochastic model is regenerated with these identified new plant parameters, a state of the plant 200 is able to be predicted appropriately even if the plant parameters are changed.

In the above described embodiment, a probability distribution is derived based on plural monitoring data (accumulated data) obtained in a predetermined past time period. If past accumulated data are not available, like when the plant 200 is newly established, a probability distribution of monitoring data may be derived based on, for example, specification data of the sensor 10.

### REFERENCE SIGNS LIST

1 HOT LEG
2 CROSSOVER LEG
3 COLD LEG
10 SENSOR
11 MAIN STEAM TEMPERATURE SENSOR
12 FEED WATER TEMPERATURE SENSOR
13 HIGH SIDE TEMPERATURE SENSOR
14 LOW SIDE TEMPERATURE SENSOR
15 PRESSURE SENSOR
16 FLOW RATE SENSOR
100 PLANT OPERATION ASSISTANCE SYSTEM
101 DATA OBTAINING UNIT
102 IDENTIFYING UNIT
103 MODEL GENERATION UNIT
104 DATA PROCESSING UNIT
105 PREDICTION UNIT
106 STORAGE UNIT
107 DETERMINING UNIT
108 UPDATING UNIT
150 OUTPUT COMMAND UNIT
200 PLANT (NUCLEAR POWER PLANT)
201 NUCLEAR REACTOR VESSEL
202 STEAM GENERATOR
203 PRESSURIZER
204 PRIMARY COOLING WATER PUMP
250 PRIMARY COOLING SYSTEM
300 CONTROL DEVICE
Tₘₛ MAIN STEAM TEMPERATURE
T_{fw} FEED WATER TEMPERATURE
Tₕₒ HIGH SIDE TEMPERATURE
T_{co} LOW SIDE TEMPERATURE
P_{rcp} PRESSURE
G_{rcp} FLOW RATE

1. A plant operation assistance system, comprising:
a data obtaining unit configured to obtain monitoring data indicating state quantity of a plant, the state quantity being detected by a sensor;
an identifying unit configured to identify, based on the state quantity, a probability distribution of the monitoring data;
a model generation unit configured to generate, based on a plant parameter composed from a database including design information of the plant, a stochastic model of the plant;
a data processing unit configured to assign the probability distribution to the monitoring data obtained by the data obtaining unit; and
a prediction unit configured to input the monitoring data assigned with the probability distribution into the stochastic model and predict a state of the plant.

2. The plant operation assistance system according to claim 1, wherein the identifying unit is configured to identify the probability distribution with an output command of the plant being an index.

3. The plant operation assistance system according to claim 1, comprising an updating unit configured to update the stochastic model with a plant parameter identified based on a deterministic model of the plant.

4. A plant operation assistance method, including steps of:
obtaining monitoring data indicating state quantity of a plant, the state quantity being detected by a sensor;
identifying, based on the state quantity, a probability distribution of the monitoring data;
generating, based on a plant parameter composed from a database including design information of the plant, a stochastic model of the plant;
assigning the probability distribution to the obtained monitoring data; and
inputting the monitoring data assigned with the probability distribution into the stochastic model and predicting a state of the plant.
